(19) United States
(12) Patent Application Publication
(10) Pub. No.: US 2024/0258017 A1
(43) Pub. Date: Aug. 1, 2024

(54) MULTI-FILAR COIL

(71) Applicant: Advanced Energy Industries, Inc., Denver, CO (US)

(72) Inventors: Paul Renan BAUI, Quezon City (PH); Joven ABELLA, Quezon City (PH)

(21) Appl. No.: 18/159,780

(22) Filed: Jan. 26, 2023

(51) Int. Cl. H01F 27/28; H01F 27/24; H01F 41/069

(52) U.S. Cl. CPC H01F 27/2828; H01F 27/24; H01F 41/069

(57) ABSTRACT

An inductive coil comprises a plurality of wires wound about a winding axis. The plurality of wires comprises a first wire wound about the winding axis at a first distance from the winding axis and a second wire wound about the winding axis adjacently to the first wire and along a full length of the first wire and at a second distance from the winding axis. A first radial distance between the first distance and the winding axis is closer to the winding axis than a second radial distance between the second distance and the winding axis by a width of the first wire.

### TECHNICAL FIELD

Aspects of the disclosure relate to power transformation, and more particularly to inductive windings.

### BACKGROUND

A power supply can be used to supply electrical energy to a load based on a percentage of an input voltage. Input currents and voltages supplied to the power controller by a power source are controllable by the power controller to transmit all of the input power to a load, none of the input power to the load, or a portion of the input power to the load. Applications for such power control include light dimmers, motor speed controllers, resistance heaters, chopper circuits, phase-control circuits, and the like. The power supply uses a power converter to convert the input voltage to an output voltage for supply to the load. The power converter can include a transformer for inductively coupling primary windings with secondary windings for isolated power handling in the converter.

The power converter may include windings formed in one or more layers of a printed circuit board (PCB). However, forming primary and secondary coil windings via PCB copper traces may result in undesirable thermal handling or parasitic loses due in part to a lack of inter- layering between the primary and secondary windings.

### SUMMARY

In accordance with one aspect of the present disclosure, an inductive coil comprises a plurality of wires wound about a winding axis. The plurality of wires comprises a first wire wound about the winding axis at a first distance from the winding axis and a second wire wound about the winding axis adjacently to the first wire and along a full length of the first wire and at a second distance from the winding axis. A first radial distance between the first distance and the winding axis is closer to the winding axis than a second radial distance between the second distance and the winding axis by a width of the first wire.

In accordance with another aspect of the present disclosure, an electrical transformer comprises a core, a first primary winding, and a second primary winding. The core comprises a first lobe and a second lobe. The first primary winding comprises a first wire encircling the first lobe at a first distance and a plurality of additional wires, each additional wire positioned adjacently to a respective first primary winding neighboring wire positioned closer to the first lobe and encircling the first lobe at a distance greater than the respective first primary winding neighboring wire. The second primary winding comprises a first wire encircling the second lobe at the first distance and a plurality of additional wires, each additional wire positioned adjacently to a respective second primary winding neighboring wire positioned closer to the second lobe and encircling the second lobe at a distance greater than the respective second primary winding neighboring wire.

### BRIEF DESCRIPTION OF THE DRAWINGS

The drawings illustrate embodiments presently contemplated for carrying out the invention.

In the drawings:

FIG. 1 is an orthogonal view of a multi-filar winding according to an embodiment.

FIG. 2 is an orthogonal view of a multi-filar winding according to another embodiment.

FIG. 3 is a cross-sectional view of a wire of the multi-filar winding of FIG. 1 according to an embodiment.

FIG. 4 illustrates a method of making the multi-filar windings of FIGS. 1, 2 according to an embodiment.

FIG. 5 is an orthogonal view of a winding formed during the process of forming the multi-filar winding of FIG. 1 according to an embodiment.

FIG. 6 is an orthogonal view of a subsequent step of the winding of FIG. 5 formed during the process of forming the multi-filar winding of FIG. 1 according to an embodiment.

FIG. 7 is an orthogonal view of a portion of a power converter incorporating the multi-filar winding of FIG. 1 according to an embodiment.

FIG. 8 is a schematic view of a relationship of primary and secondary windings of the power converter of FIG. 7 according to an embodiment.

FIG. 9 is a cross-sectional view of an assembly step of forming the power converter of FIG. 7 according to an embodiment.

FIG. 10 is an orthogonal view of another assembly step of forming the power converter of FIG. 7 according to an embodiment.

FIG. 11 is an orthogonal view of another assembly step of forming the power converter of FIG. 7 according to an embodiment.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

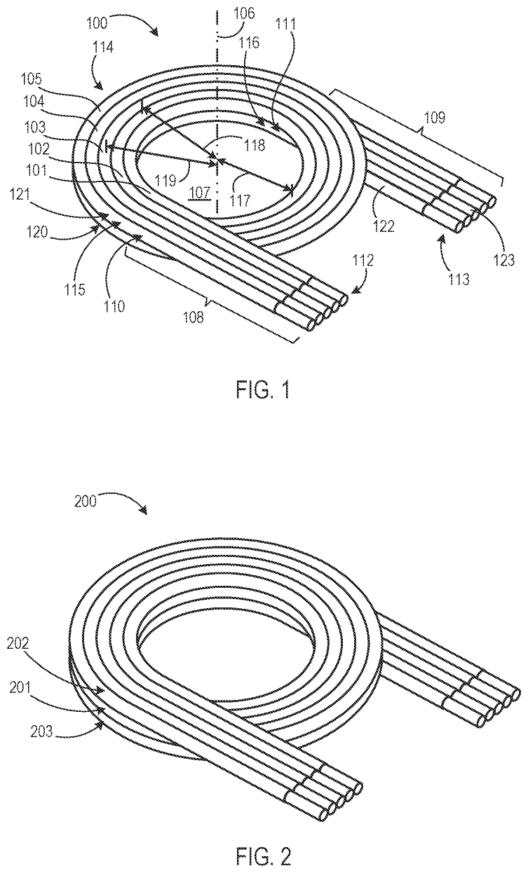

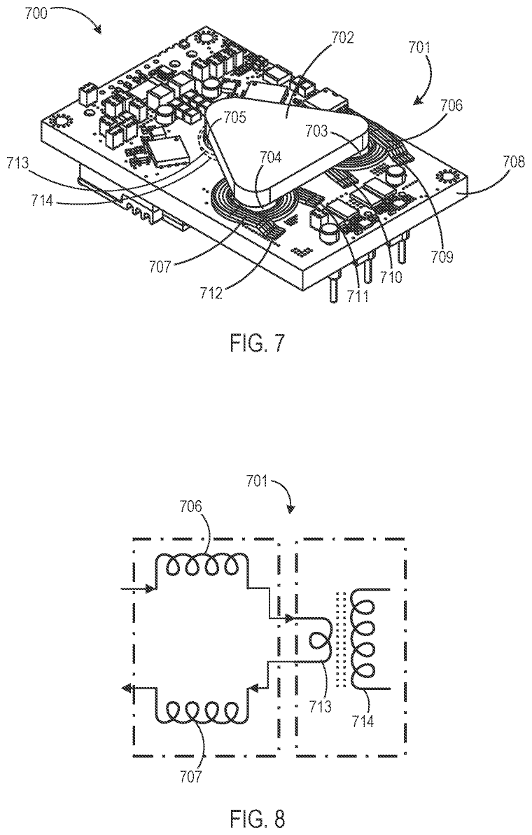

FIG. 1 illustrates a multi-filar winding 100 according to an embodiment. The multi-filar winding 100 is formed by a plurality of wires 101-105 wound about a winding axis 106. The wires 101-105 are positioned adjacently to one another in a planar arrangement and wound around a form (not shown) to provide a central opening 107 through which a transformer core limb (e.g., such illustrated in FIG. 7) may be inserted. Due to the planar manner in which the wires 101-105 are wound about the winding axis 106, the length of the inside-most wire (e.g., wire 101) is shorter than its neighbor wire (e.g., wire 102) wound adjacently thereto. Each successive wire (e.g., wires 103-105) is also successively longer than its adjacent inner neighbor wire (e.g., wires 102-104, respectively).

The multi-filar winding 100 includes first and second lead portions 108, 109 at opposite ends, each having respective first ends 110, 111 and respective second ends 112, 113. Connected between the first ends 110, 111 of the lead portions 108, 109 is a wound portion 114 that includes the portions of the wires 101-105 that are curved about the winding axis 106. A first end 115 of the wound portion 114 is coupled to the first end 110 of the first lead portion 108, and a second end 116 of the wound portion 114 is coupled to the first end 111 of the second lead portion 109. As illustrated in FIG. 1, the diameters of the wound portions 114 of the wires 101-105 are successively longer, similar to the lengths of the respective wires. Accordingly, the radial distance 117 of the wound portion 114 of the wire 101 is shorter than the radial distance 118 of the wire 102, which is shorter than the radial distance 119 of the wound portion 114 of the wire 103, etcetera.

The wires 101-105 of the wound portion 114 are wound about the winding axis 106 by more than a single turn. To have the first lead portion 108 and second lead portion 109 extend in the same direction from the wound portion 114, the wires 101-105 are wound about the winding axis 106 in odd multiples of one half greater than two. For example, as illustrated in FIG. 1, the wires 101-105 are wound about the winding axis 106 by three one half turns. In other words, the wires are wound one and a half times about the winding axis 106 to form a one-and-a-half-turn winding. Though the wires 101-105 are wound about the winding axis 106 by three one half turns, the wires 101-105 do not overlap one another by a whole turn. As illustrated, a second layer 120 of the wound wires 101-105 is overlapped by a first layer 121 by one half turn.

By way of example, FIG. 2 illustrates a multi-filar winding 200 with its wires wound about the winding axis 106 by five one half turns to form a two-and-a-half-turn winding. As shown, a second layer 201 is overlapped by a first layer 202 by a whole turn, and a third layer 203 is overlapped by the second layer 201 by one half turn. The number of turns illustrated in FIGS. 1 and 2 are merely examples, and windings having a greater number of turns may be formed within the scope of this disclosure. Furthermore, a multi-filar winding formed according to this disclosure is not limited to odd multiples of one-half turns. A multi-filar winding having a whole number of turns or having any portion of a whole turn may be contemplated within the scope of this disclosure.

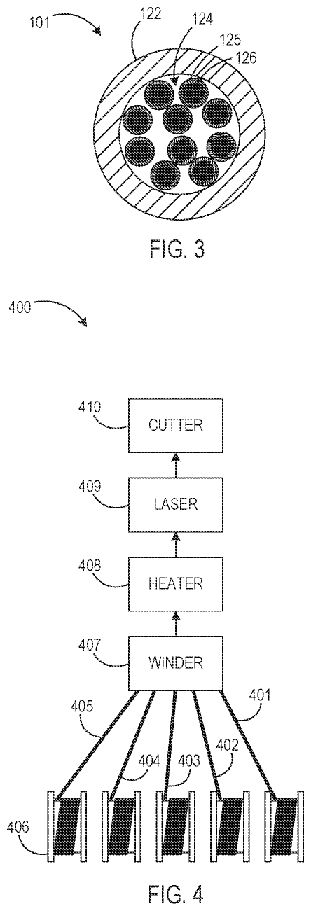

Referring to FIGS. 1 and 3, each wire 101-105 includes an electrically insulative coating 122 surrounding an electrically conductive core 123 formed of a plurality of conductive strands 124, each having its own coating 125 and conductive core 126. Removal of the coatings 122, 125 near the second ends 112, 113 of the first and second lead portions 108, 109 exposes the conductive strands 124, allowing the multi-filar winding 100 to be electrically coupled with other circuit components. In one embodiment, the wires 101-105 are Litz wires with their coatings 122 having a self-bonding property that allows the wires 101-105 to be bonded together during or after winding into the multi-filar windings 100, 200 described herein.

FIG. 4 illustrates a method 400 of making a multi-filar winding such as the multi-filar windings 100, 200 of FIGS. 1 and 2 according to an embodiment. A plurality of wires 401-405 supplied, for example, by wire bobbins 406 is provided to a winder 407 having a form about which the wires 401-405 are wound in a multi-turn, planar arrangement as described above. The wires 401-405 may be arranged in a similar manner as respective wires 101-105 of FIG. 1.

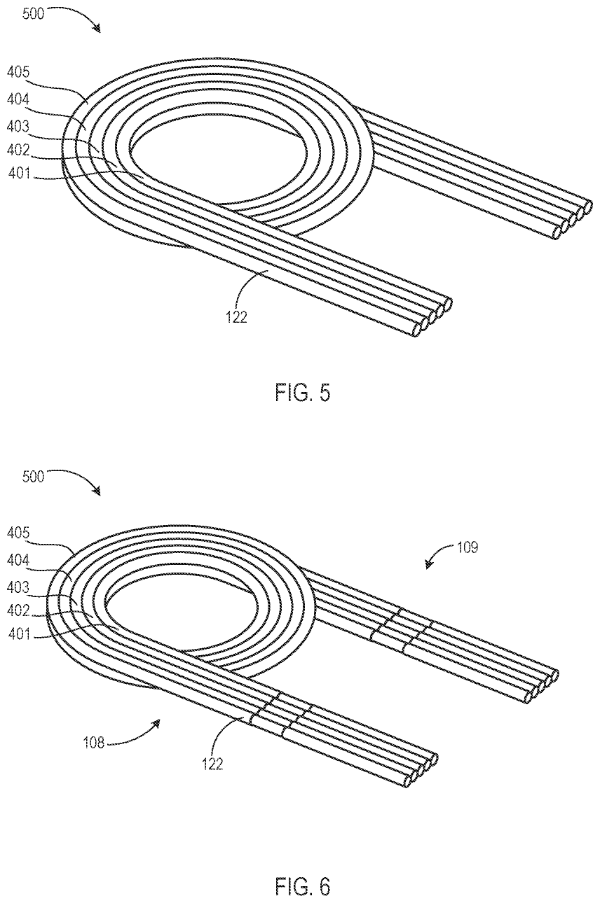

Subsequent to or during the winding of the wires 401-405, the self-bonding coatings of the wires may be activated such as by a heater 408 to solidify the wire arrangement into planar, multi-layer multi-filar strands. An example of a multi-filar winding formed to this step in the method 400 is illustrated in FIG. 5. As shown, the multi-filar winding 500 illustrates a one-and-one-half-turn winding. The coatings 122 are not yet removed at this step of the method 400.

Returning to FIG. 4, the solidified multi-filar winding 500 passes to a laser method step 409 for removal of a portion of the coating 122 to expose the conductive cores 126 of the conductive strand 124. As illustrated in FIG. 6, portions of the coatings 122 of the first and second lead portions 108, 109 and the coatings 125 of the conductive strands 124 are removed to expose the conductive cores 126. In one embodiment, a laser may be used to burn the coatings 122, 125 from the wires 401-405. As shown, portions of the coatings 122, 125 are left on the wires 401-405 on both sides of the laser removal site. However, it is contemplated that the coatings 122, 125 may be removed all the way to the ends of the first and second lead portions 108, 109.

Returning to FIG. 4, the first and second lead portions 108, 109 may be trimmed by a cutter 410 to a desired length. For example, the multi-filar winding 500 illustrated in FIG. 6 may be trimmed to have shorter first and second lead portions 108, 109 to match those illustrated in FIG. 1.

FIG. 7 illustrates an orthogonal view of a portion of a power converter 700 incorporating multi-filar windings described herein according to an embodiment. The power converter 700 incorporates a transformer 701 having multiple primary windings and at least a secondary winding. A core 702 of the transformer 701 includes three core limbs 703-705. Surrounding two of the core limbs (e.g., limbs 703, 704) are a pair of multi-filar winding 706, 707 formed as described herein. The windings 706, 707 may be primary windings corresponding to a multi-primary winding arrangement of the power converter 700. The exposed conductive core ends of the multi-filar windings 706, 707 are connected (e.g., by solder) to the power converter PCB 708 at solder points 709-712. Surrounding the third core limb 705 are a third primary winding 713 and a secondary winding 714, both formed on one or more respective layers within the PCB 708. Thus, windings 713 and 714 are formed as PCB copper trace windings while windings 706-707 are external windings coupled to the PCB 708 on an outside surface thereof.

FIG. 8 illustrates a schematic view of a relationship of primary and secondary windings 706, 707, 713, 714 of the power converter of FIG. 7 according to an embodiment.

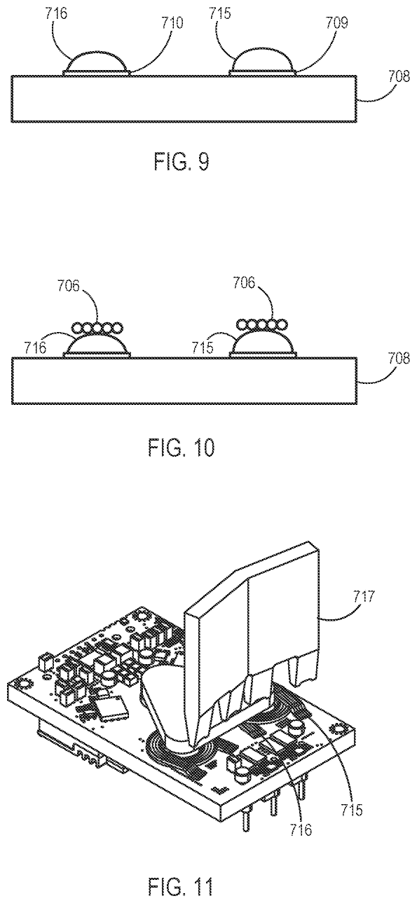

FIGS. 9-11 illustrate example steps of attaching the multi-filar winding 706 to the solder points 709, 710 according to an embodiment. A cross-sectional view of a portion of the PCB 708 is shown in FIG. 9 adjacent to the solder points 709, 710. The solder points 709, 710 are PCB contact pads formed on a surface of the PCB 708. A solder ball 715, 716 is respectively added to each solder point 709, 710. As illustrated in FIG. 10, the exposed ends of the multi-filar winding 706 are positioned adjacently to the solder balls 715, 716. FIG. 11 illustrates a heating element 717 of a hot bar soldering technique positioned above the solder balls 715, 716. As the heating element 717 is lowered into contact with the winding ends and the solder balls 715, 716, the solder balls 715, 716 heat up and flow about the exposed ends of the multi-filar winding 706 to couple the winding 706 to the solder pads 709, 710.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

1. An inductive coil comprising:
a plurality of wires wound about a winding axis and comprising:
a first wire wound about the winding axis at a first distance from the winding axis;
a second wire wound about the winding axis adjacently to the first wire and along a full length of the first wire and at a second distance from the winding axis;
wherein a first radial distance between the first distance and the winding axis is closer to the winding axis than a second radial distance between the second distance and the winding axis by a width of the first wire.

2. The inductive coil of claim 1, wherein the plurality of wires further comprises a third wire wound about the winding axis adjacently to the second wire and along a full length of the second wire and at a third distance from the winding axis;
wherein the second radial distance is closer to the winding axis than a third radial distance between the third distance and the winding axis by a width of the second wire.

3. The inductive coil of claim 1, wherein the first wire and the second wire comprise:
a first lead portion having a first end and a second end;
a second lead portion having a first end and a second end; and
a wound portion having a first end and a second end;
wherein the first end of the first lead portion is coupled with the first end of the wound portion; and
wherein the first end of the second lead portion is coupled with the second end of the wound portion.

4. The inductive coil of claim 3, wherein the wound portion is wound about the winding axis greater than a single turn.

5. The inductive coil of claim 4, wherein the wound portion is wound about the winding axis by one and a half turns.

6. The inductive coil of claim 5, wherein the wound portion overlaps itself by one half turn.

7. The inductive coil of claim 3, wherein the wound portion is wound about the winding axis greater than two turns.

8. The inductive coil of claim 3, wherein each of the first wire and the second wire comprises:
a plurality of electrically conductive strands; and
an electrically insulative coating surrounding the plurality of electrically conductive strands.

9. The inductive coil of claim 8, wherein the electrically insulative coating adjacent to the second end of the first lead portion and adjacent to the second end of the second lead portion is laser-removed to bare the plurality of electrically conductive strands adjacent to the second ends of the first and second lead portions.

10. The inductive coil of claim 3, wherein each of the first wire and the second wire comprises a Litz wire.

11. An electrical transformer comprising:
a core comprising a first lobe and a second lobe;
a first primary winding comprising:
a first wire encircling the first lobe at a first distance; and
a plurality of additional wires, each additional wire positioned adjacently to a respective first primary winding neighboring wire positioned closer to the first lobe and encircling the first lobe at a distance greater than the respective first primary winding neighboring wire;
a second primary winding comprising:
a first wire encircling the second lobe at the first distance; and
a plurality of additional wires, each additional wire positioned adjacently to a respective second primary winding neighboring wire positioned closer to the second lobe and encircling the second lobe at a distance greater than the respective second primary winding neighboring wire.

12. The electrical transformer of claim 11, wherein a length of each additional wire of the first primary winding is longer than a length of its respective first primary winding neighboring wire.

13. The electrical transformer of claim 11, wherein the core further comprises a third lobe; and
wherein the electrical transformer further comprises:
a third primary winding formed in a first printed circuit board (PCB) layer and encircling the third lobe; and
a first secondary winding formed in a second PCB layer and encircling the third lobe.

14. The electrical transformer of claim 11, wherein the wires of the first and second primary windings comprise Litz wires having a plurality of electrically conductive strands and an electrically insulative coating surrounding the plurality of electrically conductive strands;
wherein the Litz wires of the first primary winding are coupled together to form a first planar group of wires having the first wire of the first primary winding encircling the first lobe at the first distance closer than the distance of an outside wire of the planar group of wires farthest from the first wire of the first primary winding.

15. The electrical transformer of claim 14, wherein the Litz wires of the second primary winding are coupled together to form a second planar group of wires having the first wire of the second primary winding encircling the second lobe at the first distance closer than the distance of an outside wire of the second planar group of wires farthest from the first wire of the second primary winding.

16. The electrical transformer of claim 14, wherein the first planar group of wires comprises:
a first lead portion having a first end and a second end;
a second lead portion having a first end and a second end; and
a wound portion having a first end and a second end;
wherein the first end of the first lead portion is coupled with the first end of the wound portion; and
wherein the first end of the second lead portion is coupled with the second end of the wound portion.

17. The electrical transformer of claim 16, wherein the electrically insulative coating adjacent to the second end of the first lead portion and adjacent to the second end of the second lead portion is removed to expose the plurality of electrically conductive strands adjacent to the second ends of the first and second lead portions.

18. The electrical transformer of claim 17 wherein the exposed plurality of electrically conductive strands adjacent to the second ends of the first and second lead portions are soldered to respective electrical pads of a PCB.

19. The electrical transformer of claim 16, wherein the wound portion is wound about the first lobe greater than a single turn.

20. The electrical transformer of claim 19, wherein the wound portion is wound about the first lobe by one and a half turns.
